(19) United States
(12) Patent Application Publication
(10) Pub. No.: US 2015/0121282 A1
(43) Pub. Date: Apr. 30, 2015

(54) DYNAMIC VIRTUAL KEYBOARD RESPONSIVE TO GEOGRAPHIC LOCATION

(71) Applicant: International Business Machines Corporation, Armonk, NY (US)

(72) Inventors: Paul D. Kangas, Raleigh, NC (US); Daniel M. Ranck, Cary, NC (US)

(73) Assignee: International Business Machines Corporation, Armonk, NY (US)

(21) Appl. No.: 14/066,732

(22) Filed: Oct. 30, 2013

(51) Int. Cl. G06F 3/0488

(52) U.S. Cl. CPC G06F 3/04886
USPC 715/773

(57) ABSTRACT

A computer program product (CPP) includes program code for controlling a virtual keyboard on a mobile communications device having a touchscreen. The CPP product includes program code for identifying a geographic location of a mobile communication device, wherein the mobile communication device has a touchscreen operable as a virtual keyboard. The CPP further includes program code for identifying a first keyboard character associated with the identified geographic location that is a location-variant of a second keyboard character associated with a standard keyboard layout of the mobile communication device, and program code for modifying the standard keyboard layout to make the first keyboard character more accessible within the modified keyboard layout than within the standard keyboard layout. For example, the first keyboard character may be made more accessible by substituting the first keyboard character for the second keyboard character on the virtual key.

### BACKGROUND

1. Field of the Invention

The present invention relates to the use of a virtual keyboard on the touchscreen of a mobile communication device.

2. Background of the Related Art

When a smart phone user travels from one region of the world to another, it can be difficult to find and use local characters and symbols for that specific geographic location. The phone's active or default keyboard layout or map (i.e. US keyboard layout) does not include many of the characters or symbols that may be needed or used routinely while visiting a new geographic location. Still, the user may continue to handle personal or business communications, such as text or email messages, in their usual manner and may not want to be constantly changing their standard, active keyboard layout preference.

### BRIEF SUMMARY

One embodiment of the present invention provides a computer program product including computer readable program code embodied on a computer readable storage medium. The computer program product includes computer readable program code for identifying a geographic location of a mobile communication device, wherein the mobile communication device has a touchscreen operable as a virtual keyboard. The computer program product further includes computer readable program code for identifying a first keyboard character associated with the identified geographic location that is a location-variant of a second keyboard character associated with active standard keyboard layout of the mobile communication device, and computer readable program code for modifying the standard keyboard to make the first keyboard character more accessible within the modified keyboard layout than within the standard keyboard layout.

### BRIEF DESCRIPTION OF THE SEVERAL VIEWS OF THE DRAWINGS

FIG. 1 is a system diagram for a mobile communication device, such as a smart phone.

FIG. 2 is a diagram of a standard keyboard layout showing a currency symbol changing from a United States dollar sign ($) to a British pound (£) as being displayed on a virtual key of the modified keyboard layout.

FIG. 3 is a diagram of a standard keyboard layout having a location-aware virtual key that can produce a hover list with location variants of characters in the standard keyboard layout.

FIG. 4 is a diagram of a virtual keyboard layout that highlights the virtual keys in the standard keyboard layout that have a location variant accessible through a hover list.

FIG. 5 is a diagram of a virtual keyboard layout displaying a prompt for user input regarding a change to a standard keyboard layout associated with the identified geographic location of the mobile communications device.

FIG. 6 is a flowchart of a method in accordance with one embodiment of the invention.

### DETAILED DESCRIPTION

One embodiment of the present invention provides a method comprising identifying a geographic location of a mobile communication device, wherein the mobile communication device has a touchscreen operable as a virtual keyboard. The method further comprises identifying a first keyboard character associated with the identified geographic location that is a location-variant of a second keyboard character associated with a standard keyboard layout of the mobile communication device, and modifying the standard keyboard layout to make the first keyboard character more accessible within the modified keyboard layout than within the standard keyboard layout.

In one option, the step of identifying the geographic location of the mobile communication device may include identifying a geopolitical region, such as a country. In a further option, the step of identifying a geographic location of a mobile communication device may include identifying a new geographic location of the mobile communications device. For example, the method may identify that the mobile communications device is in a new geographic location, i.e., has just crossed a boundary from one geographic location into the new geographic location. The first and second keyboard characters may be currency symbols, wherein the first currency symbol is associated with the new geographic location, such that access to the first currency symbol is made more accessible in response to identifying a new geographic location of the mobile communications device.

In a further embodiment, the method may further include multiple alternate forms of the first keyboard character in a hover list displayed by pressing and holding a virtual key displaying the first keyboard character.

In another embodiment, the method may further comprise displaying a prompt for user input to change the keyboard layout from the active standard keyboard layout to a different keyboard layout associated with the new geographic location, wherein modifying the standard keyboard layout to make the first keyboard character more accessible includes changing the keyboard layout from the active standard keyboard layout to the different standard keyboard layout associated with the new geographic location in response to user input to the prompt. For example, the new geographic location may be a country, and the standard keyboard layout associated with the country may include keyboard characters for a specific language predominantly used in that country.

The first keyboard character may be included in a keyboard character set that is associated with the identified geographic location, such as a keyboard character set that is specific to a language that is predominantly used in that geographic location.

The geographic location of the mobile communication device may be identified, for example, by receiving a signal from a global positioning system. Alternatively, the geographic location of the mobile communications device may be identified by the cell tower or switching station that is closest to the mobile communications device. Optionally, the geographic location be a geopolitical region.

In one option, modifying the standard keyboard layout to make the first keyboard character more accessible within the standard keyboard, includes automatically substituting the first keyboard character for the second keyboard character in the standard keyboard layout. The virtual key displaying the first keyboard character may be highlighted to indicate that the keyboard character has be substituted due to the identified geographic location. The method may, in one example, then maintain access to the second keyboard character through a hover list displayed by pressing and holding a virtual key displaying the first keyboard character.

In another option, modifying the standard keyboard layout to make the first keyboard character more accessible within the standard keyboard, includes adding the first keyboard character to a hover list displayed by pressing and holding the virtual key displaying second keyboard character. The virtual key displaying the second keyboard character may be highlighted to indicate that pressing and holding the virtual key displaying the second keyboard character will produce a hover list that includes the first keyboard character.

In yet another embodiment, a location-aware virtual key may be added to the keyboard layout, wherein pressing and holding the location-aware virtual key provides a hover list of keyboard characters associated with the identified geographic location that are location-variants of keyboard characters associated with the active keyboard layout of the mobile communication device. Optionally, the location-aware virtual key may be to indicate that the location-aware virtual key provides a hover list of keyboard characters associated with the identified geographic location. In a further option, the hover list may include a hot key that is not a keyboard character, and wherein pressing and holding the hot key displays a description of the keyboard characters in the hover list.

In a further embodiment, the first keyboard character becomes associated with the identified geographic location by monitoring the use of first and second keyboard characters by mobile communication devices in the geographic region including the identified geographic location, and associating the first keyboard character with a identified geographic location in response to determining that first keyboard character is used more frequently by mobile communication devices in the geographic region than the second keyboard character.

For example, when traveling to England from the United States, a user of a smart phone may be more frequently entering the British pound symbol in text messages, emails, and other documents or communications. Accordingly, the methods of the present invention may make the local currency symbol more accessible to the user of a virtual keyboard, such as by changing the default currency virtual key to display and represent entry of the local currency symbol while continuing to provide access to other characters and symbols, such as the U.S. dollar, in a select list. A server coupled to the communication system may monitor and track British pound usage by many users of mobile communications devices at various locations in order to continuously or periodically validate that the British pound is the predominant (or exceeds some of other usage setpoint or test conditions) keyboard character for currency. For example, a virtual keyboard app may transmit virtual key presses to a central server from all the smart phone users of this keyboard app. If Britain were to change its currency to the Euro, the central server would detect widespread Euro button usage, while would lead to a change in the default currency symbol for identified geographical locations within Britain. Other non-limiting examples of dynamic symbol keys may include tilde, accent marks, “upside-down” question marks and exclamation points. Optionally, the default or active keyboard layout is not changed (i.e., is still a US keyboard layout), but only a subset of keys are changed. By collection character and/or symbol usage by mobile communications devices in various geographical locations, the central server may create digital maps having symbol usage boundaries.

Another embodiment of the present invention provides a computer program product including computer readable program code embodied on a computer readable storage medium. The computer program product includes computer readable program code for identifying a geographic location of a mobile communication device, wherein the mobile communication device has a touchscreen operable as a virtual keyboard. The computer program product further includes computer readable program code for identifying a first keyboard character associated with the identified geographic location that is a location-variant of a second keyboard character associated with a standard keyboard layout of the mobile communication device, and computer readable program code for modifying the standard keyboard layout to make the first keyboard character more accessible within the virtual keyboard than within the standard keyboard layout.

The foregoing computer program products may further include computer readable program code for implementing or initiating any one or more aspects of the methods described herein. Accordingly, a separate description of the methods will not be duplicated in the context of a computer program product.

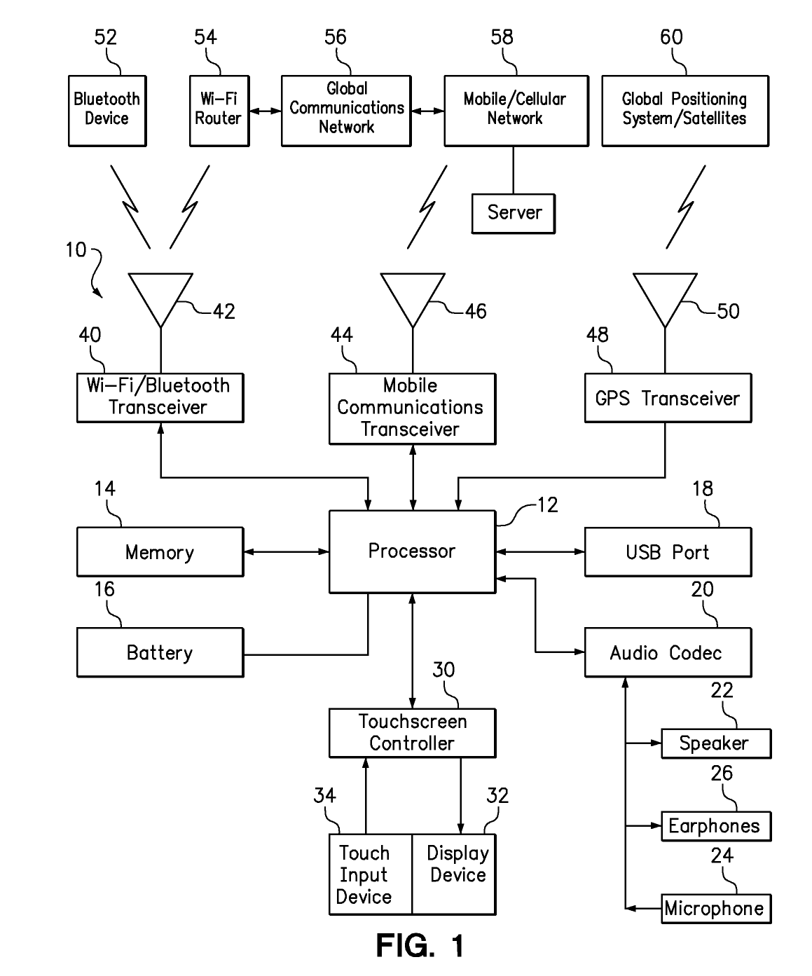

FIG. 1 is a system diagram for a mobile communications device 10, such as a smart phone. The mobile communications device 10 may include a processor 12, memory 14, a battery 16, a universal serial bus (USB) port 18, and an audio codec 20 coupled to a speaker 22, a microphone 24, and an earphone jack 26. The device 10 may further include a touchscreen controller 30 which provides a graphical output to the display device 32 and an input from a touch input device 34. Collectively, the display device 32 and touch input device 34 may be referred to as a touchscreen. A touchscreen may be used to implement a virtual keyboard, where the touchscreen controller 30 instructs the display device 32 to display an image of a keyboard with keys labeled with characters or symbols. Touching the touch input device 34 in a location aligned with a particular virtual key of the display is interpreted by the touchscreen controller 30 as a selection of that particular key. A character or symbol assigned to that virtual key, as part of a keyboard layout, is therefore input and may be passed to the processor.

The device 10 may also include a wi-fi and/or Bluetooth transceiver 40 and corresponding antenna 42 allowing the device to communicate with a Bluetooth device 52 or a wi-fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the wi-fi router 54 and the mobile/cellular network 58 may be connected to a global communications network 56, such as the Internet. Furthermore, mobile/cellular network 58 may include or access a server for the purpose of storing and implementing associations between geographical locations and keyboard characters, symbols and layouts.

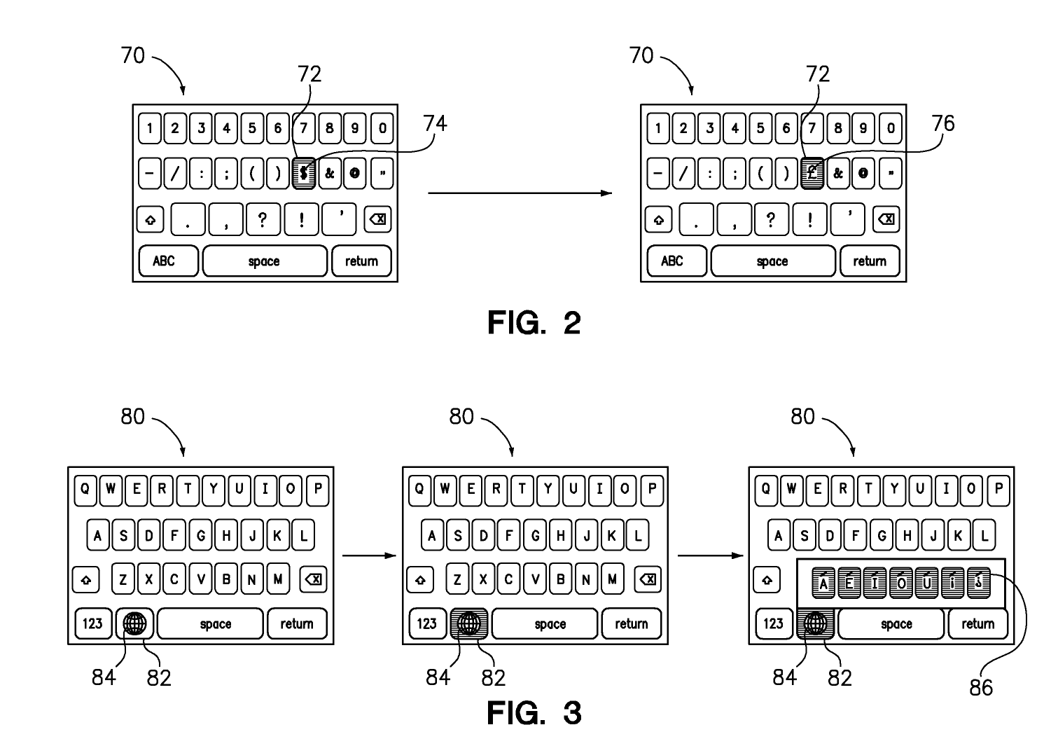

FIG. 2 is a diagram of a virtual keyboard 70, as might be displayed on the display device 32 of FIG. 1, showing a currency symbol (see virtual key 72) changing from a United States dollar sign ($) 74 in the left-hand image to a British pound (£) 76 in the right-hand image. The overall keyboard layout has not been changed, but only the currency symbol on virtual key 72 has been changed. By way of example, the change shown may have resulted from a user from the U.S. traveling to England. England is a geopolitical designator associated with a new geographical location of the mobile communications device, where England is associated with the British pound as the predominant currency symbol.

FIG. 3 is a diagram of a virtual keyboard 80 having a location-aware virtual key 82 (shown with a globe icon) added to the active keyboard layout adjacent the space bar. The left-hand image shows the location-aware virtual key 82 inactive, since the identified geographic location of the mobile communication device is consistent with the active keyboard layout. In the middle image, the location-aware virtual key 82 is highlighted to indicate that the virtual key can produce a hover list. By pressing and holding the location-aware virtual key 82, a hover list 86 is displayed as shown in the right-hand image. The hover list 86 may include a list or summary of local variants to keyboard characters in the active standard keyboard layout. A user may touch-select any of the characters or symbols displayed on the hover list to cause an entry of the touched character or symbol.

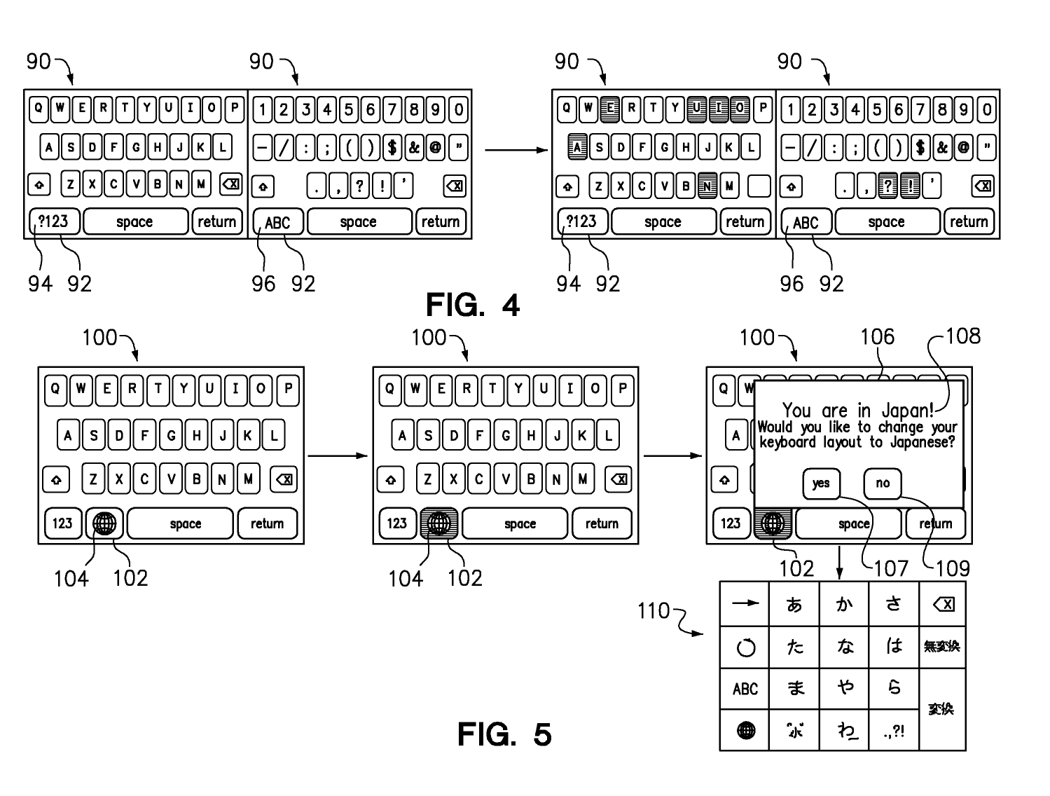

FIG. 4 is a diagram of a standard keyboard layout 90 that highlights the keys in the standard keyboard layout that have a location variant accessible through a hover list. The left-most image of the virtual keyboard layout 90 displays a shift key 92 that is currently displaying symbols and numbers 94. Accordingly, touching the shift key 92 will cause the keyboard layout to display symbols and numbers, as shown in the image just to the right. Note that the shift key 92 now displays alphabetic characters, indicating that touching the shift key 92 will not cause the keyboard layout to display alphabetic characters as shown in the left-most image.

On the right-hand side of the arrow, the same two images of the standard keyboard layout 90 are shown, except that several of the keys are highlighted. The several keys are highlighted to indicate to a user that those keys will produce a hover list displaying local variants of the keyboard characters or symbols displayed on the key. For example, when traveling from the United States to a Spanish-speaking country, all characters and symbols on the virtual keyboard with international-equivalent characters are highlighted, notifying the user that they are able to access location-related characters and symbols in a hover list by pressing and holding one of the highlighted keys.

FIG. 5 is a diagram of a virtual keyboard 100 having a location-aware virtual key 102 (shown with a globe icon 104) added to the standard keyboard layout adjacent the space bar. The left-hand image shows the location-aware virtual key 102 inactive, since the identified geographic location of the mobile communication device is consistent with the standard keyboard layout. In the middle image, the mobile communications device is in a new geographic location, such that the location-aware virtual key 102 is highlighted to indicate that the virtual key can produce a hover list. By pressing and holding the location-aware virtual key 102, a hover list 106 is displayed as shown in the right-hand image. In this case, the hover list 106 displays a prompt for user input regarding a change to a different standard keyboard layout that is associated with the new identified geographic location of the mobile communications device. Touching the positive input virtual key 107 (i.e., “yes”) will cause the keyboard layout to change to the new standard keyboard layout, such as the Japanese standard keyboard layout 110 shown in the lower right-hand image. Touching the negative input virtual key 109 (i.e., “no”) will cause the keyboard layout to remain the same, such as the US standard keyboard layout shown in the middle image. Alternatively, if the user had set appropriate settings in the mobile communications device, then changing to a new standard keyboard layout might be performed automatically without a prompt.

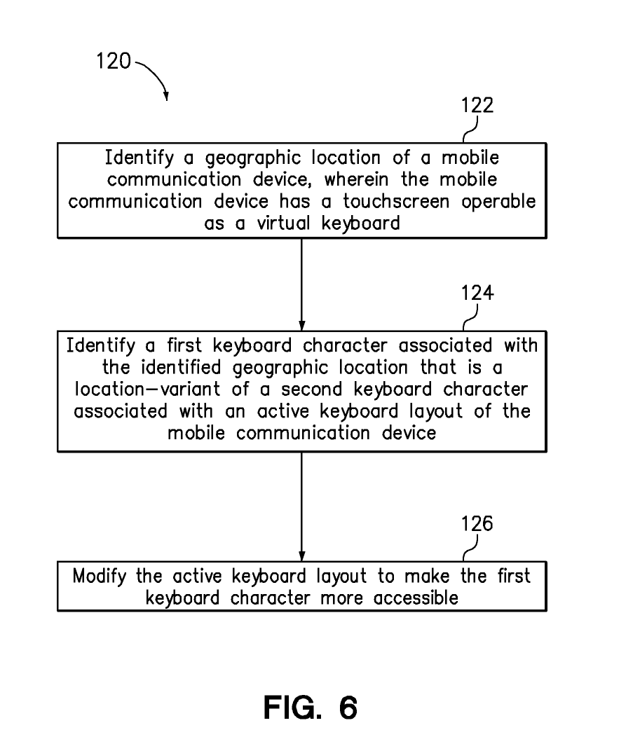

FIG. 6 is a flowchart of a method 120 in accordance with one embodiment of the invention. In step 122, the method identifies a geographic location of a mobile communication device, wherein the mobile communication device has a touchscreen operable as a virtual keyboard. In step 124, the method identifies a first keyboard character associated with the identified geographic location that is a location-variant of a second keyboard character associated with a standard keyboard layout of the mobile communication device. In step 126, the method modifies the standard keyboard layout to make the first keyboard character more accessible within the modified standard keyboard layout than within the standard keyboard layout. As disclosed herein, the present invention provides various ways to make the first keyboard character more accessible.

It should be understood that the terms “association” or “associated” are used in this application to indicate a relationship between two entities. The nature of the association may be clear from the context, but may include a relationship within a data storage structure. For example, a keyboard character may be associated with a standard keyboard layout when the standard keyboard layout includes the keyboard character, which may be manifested by the keyboard character being stored in a list, database, or file of keyboard characters that are utilized by the standard keyboard layout. As another example, a keyboard character may be associated with a geographic location by storing the keyboard character in a list, database, or file of keyboard characters that are predominantly used in that geographic location. Still further, all of the “associations” may be maintained in a relational database, such that the characters and symbols are stored in relation to a particular standard keyboard layout, and standard keyboard layouts are stored in relation to geographic locations. Geographic locations may also be associated with a geopolitical entity, such as a country, by a digital map or the equivalent thereof. An “association” may be established from storing two items in a common record or a common file, or storing two items with a common cross-reference. Similarly, the term “location-variant” means that two characters are of the same type, but differ primarily due to the location where the characters are used. For example, a currency symbol can have location-variants, where a British pound (£) is a location-variant of a United States dollar ($).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer program product including computer readable program code embodied on a computer readable storage medium, the computer program product including:
computer readable program code for identifying a geographic location of a mobile communication device, wherein the mobile communication device has a touchscreen operable as a virtual keyboard;
computer readable program code for identifying a first keyboard character associated with the identified geographic location that is a location-variant of a second keyboard character associated with a standard keyboard layout of the mobile communication device; and
computer readable program code for modifying the standard keyboard layout to make the first keyboard character more accessible within the modified keyboard layout than within the standard keyboard layout.

2. The computer program product of claim 1, wherein the computer readable program code for modifying the standard keyboard layout to make the first keyboard character more accessible within the modified keyboard layout, includes computer readable program code for automatically substituting the first keyboard character for the second keyboard character on the standard keyboard layout.

3. The computer program product of claim 2, further comprising:
computer readable program code for maintaining access to the second keyboard character through a hover list displayed by pressing and holding a virtual key displaying the first keyboard character.

4. The computer program product of claim 2, further comprising:
computer readable program code for highlighting a virtual key displaying the first keyboard character.

5. The computer program product of claim 1, wherein computer readable program code for modifying the standard keyboard layout to make the first keyboard character more accessible within the modified keyboard layout, includes computer readable program code for adding the first keyboard character to a hover list displayed by pressing and holding the virtual key displaying the second keyboard character.

6. The computer program product of claim 5, further comprising:
computer readable program code for highlighting the virtual key displaying the second keyboard character.

7. The computer program product of claim 1, wherein computer readable program code for identifying the geographic location of the mobile communication device, includes computer readable program code for receiving a signal from a global positioning system.

8. The computer program product of claim 7, wherein the signal from the global positioning system is identified with a geopolitical region.

9. The computer program product of claim 1, wherein computer readable program code for identifying the geographic location of the mobile communication device, includes computer readable program code for identifying a geopolitical region where the mobile communication device is located.

10. The computer program product of claim 1, wherein the first keyboard character is included in a keyboard character set associated with the identified geographic location.

11. The computer program product of claim 10, wherein the keyboard character set is specific to a language.

12. The computer program product of claim 1, wherein computer readable program code for identifying a geographic location of a mobile communication device, includes computer readable program code for identifying a new geographic location of the mobile communications device.

13. The computer program product of claim 12, wherein the first and second keyboard characters are currency symbols.

14. The computer program product of claim 12, further comprises:
computer readable program code for displaying a prompt for user input to change the user's active standard keyboard layout to a different standard keyboard layout associated with the new geographic location, wherein modifying the standard keyboard layout to make the first keyboard character more accessible includes changing the active standard keyboard layout to the different standard keyboard layout associated with the new geographic location in response to user input to the prompt.

15. The computer program product of claim 14, wherein the new geographic location is a country, and the standard keyboard layout associated with the country is for a specific language spoken in that country.

16. The computer program product of claim 1, further comprising:
computer readable program code for including multiple alternate forms of the first keyboard character in a hover list displayed by pressing and holding a virtual key displaying the first keyboard character.

17. The computer program product of claim 1, further comprising:
computer readable program code for adding a location-aware virtual key to the keyboard layout, wherein pressing and holding the location-aware virtual key provides a hover list of keyboard characters associated with the identified geographic location that are location-variants of keyboard characters associated with the active standard keyboard layout of the mobile communication device.

18. The computer program product of claim 17, further comprising:
computer readable program code for highlighting the location-aware virtual key to indicate that the location-aware virtual key provides a hover list of keyboard characters associated with the identified geographic location.

19. The computer program product of claim 17, wherein the hover list includes a hot key that is not a keyboard character, and wherein pressing and holding the hot key displays a description of the keyboard characters in the hover list.

20. The computer program product of claim 1, further comprising computer readable program code for associating the first keyboard character with the identified geographic location by:
monitoring the use of first and second keyboard characters by mobile communication devices in the geographic region including the identified geographic location; and
associating the first keyboard character with a identified geographic location in response to determining that first keyboard character is used more frequently by mobile communication devices in the geographic region than the second keyboard character.
